(19) United States
(12) Patent Application Publication
(10) Pub. No.: US 2010/0058660 A1
(43) Pub. Date: Mar. 11, 2010

(54) UTILITY PEDESTAL COVER OR PLANTER

(75) Inventor: Carl D. WILLIAMS, Akron, OH (US)

Correspondence Address: HAHN LOESER & PARKS, LLP, One GOJO Plaza, Suite 300, AKRON, OH, 44311-1076, US

(73) Assignee: DOUGLAS FAYE ENTERPRISES, Akron, OH (US)

(21) Appl. No.: 12/555,989

(22) Filed: Sep. 9, 2009

Related U.S. Application Data
(60) Provisional application No. 61/095,426, filed on Sep. 9, 2008.

(51) Int. Cl. A01G 9/02; B65D 65/02

(52) U.S. Cl. 47/86; 47/65.5; 150/154

(57) ABSTRACT

The invention relates to a utility pedestal cover which may be used to encapsulate and conceal a utility pedestal. The material of the sleeve member may be of a weatherproof material, and may include a fastening system to allow the sleeve to be selectively opened and closed along at least a portion of its length or height, or to attach sections of the cover. The invention also relates to a planter arrangement for concealment of a utility pedestal, wherein the planter includes at least one housing section with at least one planting well. The housing may have a height such that upon introducing plants in the planting medium, the plantings and the housing effectively conceal the utility pedestal. The planting well may have at least one drain hole therein. The housing may be formed in at least two sections, which may be selectively attached around the pedestal.

### CROSS-REFERENCE TO RELATED APPLICATIONS/INCORPORATION BY REFERENCE

This patent application claims priority to and the benefit of U.S. Provisional Patent Application Ser. No. 61/095,426 filed on Sep. 9, 2008, which is incorporated herein by reference in its entirety.

### FIELD OF INVENTION

The present invention relates to utility pedestal covers and planters, and more particularly, to covers and planters that have a particular configuration to assist in the concealment of utility pedestals.

### BACKGROUND OF THE INVENTION

Currently, many building codes for residential dwellings or owner's preferences have resulted in utility lines, such as telephone, electric, cable TV, high speed Internet lines, being located underground. Utility pedestals project upwardly from the ground in order to provide access to these underground lines. These utility pedestals are located around the residence and are not conducive to the aesthetic appearance of the property because they are unsightly and unattractive.

Although utility pedestals allow utility workers the ability to quickly perform maintenance on the lines, as well as the ability to diagnose or enhance the performance of the lines using active and passive devices that are attached to the utility lines, these utility pedestals are unattractive because of their location, configuration, color, and shape.

The area around the utility pedestals is also difficult to maintain because one has to be careful not to damage the utility pedestal. In this case, there are times when the immediate landscape area around the utility pedestal cannot be maintained and unwanted grass or weed growth occurs, which adds to the unsightly appearance of the utility pedestal.

Accordingly, there is a need to make the utility pedestal cover or planter more aesthetically pleasing.

### BRIEF SUMMARY

Embodiments of the present invention pertain to covers and planters which may conceal utility pedestals.

In one embodiment of the present invention, a utility pedestal cover includes an outer sleeve member, which may be used to encapsulate and conceal a utility pedestal, wherein the sleeve member is designed to allow easy access to the utility pedestal when needed. The material of the sleeve member may be a weatherproof material. The sleeve member may also have a fastening system to allow the sleeve to be selectively opened and closed along at least a portion of its length or height. In another aspect of embodiments of the subject invention, the sleeve member comprises a bottom skirt, which may deter vegetation growth around the utility pedestal.

In another embodiment of the present invention, a planter arrangement is provided for concealment of a utility pedestal, wherein the planter includes a housing having at least one cavity in which soil or other planting medium may be selectively contained, wherein the housing has at least one central open area configured to surround a utility pedestal. The housing may have a height such that upon introducing plants in the planting medium, the plantings and the housing effectively conceal the utility pedestal. The housing may have the at least one cavity formed with at least one shelf having at least one drain hole therein, such that excessive water introduced into the planting medium can be drained as needed. The housing may also be formed in at least two sections, and the at least two sections may be selectively interlocked if desired. In yet another aspect of embodiments of the subject invention, the utility pedestal planter may comprise a bottom skirt, which may deter vegetation growth around the utility pedestal planter.

In another embodiment of the present invention, a method for concealing a utility pedestal includes the steps of providing a utility pedestal cover comprising a sleeve member having a height to correspond to the utility pedestal to be concealed, the sleeve member having a fastening system along at least a portion of its height, to allow the sleeve member to be selectively opened and closed. Opening the sleeve member and positioning the sleeve member over the utility pedestal and closing the fastening system such that the sleeve member is closely covering the utility pedestal. Another method to conceal a utility pedestal includes the steps of providing a planter system having a housing member, disposing the housing member in close relation to the utility pedestal and providing plantings in the planter system to conceal the utility pedestal. The provided planter system may have at least two housing sections that are selectively positioned relative to one another to conceal the utility pedestal, and the housing sections may be hingedly engaged to one another to allow positioning in a first open position and a second closed position, wherein the housing sections are disposed around the utility pedestal in the open position and selectively moved to the closed position to surround the utility pedestal.

### BRIEF DESCRIPTION OF THE DRAWINGS

FIG. 1 is a rear elevational view of an embodiment of a cover for a utility pedestal according to the embodiments of the subject invention.

FIG. 2 is a front elevational view of an embodiment of a cover for a utility pedestal according to the embodiments of the subject invention.

FIG. 3 is a rear elevational view of an alternate embodiment of a cover for a utility pedestal according to the embodiments of the subject invention.

FIG. 3A is an alternate embodiment of a cover according to the invention.

FIG. 4 is a front view of an embodiment of a planter for a utility pedestal according to the embodiments of the subject invention.

FIG. 5 is a side view of an embodiment of a planter for a utility pedestal according to the embodiments of the subject invention.

FIG. 6 is a top plan view of an embodiment of a planter for a utility pedestal according to the embodiments of the subject invention.

FIG. 7 is a side view of an alternate embodiment of a planter for a utility pedestal according to the embodiments of the subject invention.

FIG. 8 is a front elevational view of an alternate embodiment of a planter that is in an opened position for a utility pedestal according to the embodiments of the subject invention.

FIGS. 9A and 9B show alternative embodiments of planter arrangements according to the invention.

### DETAILED DESCRIPTION OF THE INVENTION

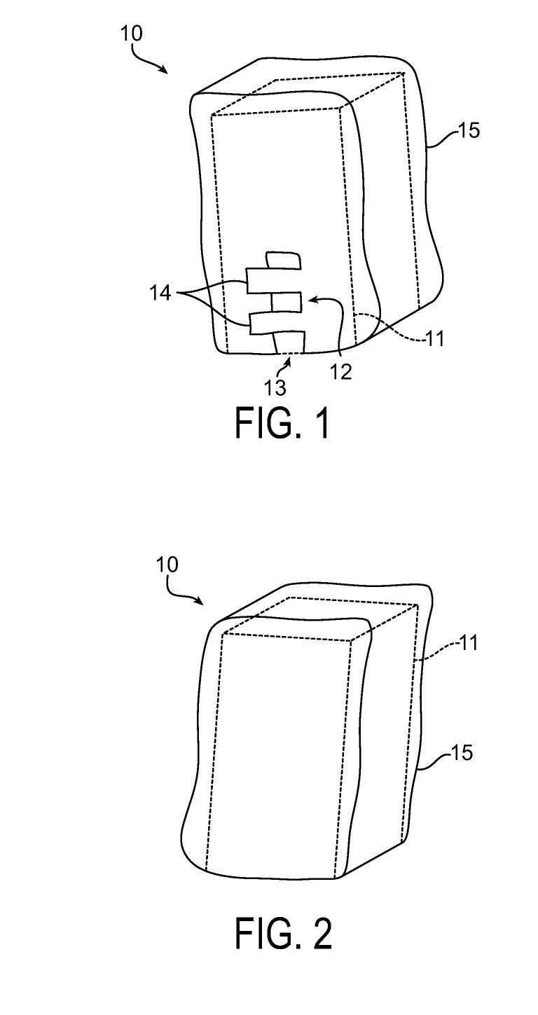

Referring now to the drawings wherein the embodiments or examples shown are for purposes of illustrating aspects of the invention only and not for purposes of limiting the same. FIG. 1 shows a first example of a utility pedestal cover 10 that may envelope a utility pedestal 11. The utility pedestal 11 is generally formed to have a metal exterior in a variety of shapes, with an appearance that is not aesthetically pleasing. The utility pedestal cover 10 may comprise at least one sleeve member 15 and a fastening system 12. In this embodiment, the fastening system 12 comprises a slit 13 in the sleeve member 15 along at least a portion of the height of sleeve member 15, with at least one fastener 14 provided to selectively close the slit 13, but more fasteners may be utilized depending on the height of the utility pedestal 11. As shown, the utility pedestal 11 is formed as a columnar housing, but larger pedestal configurations are used, and for such configurations, a plurality of fastening systems 12 may be provided, such as a plurality of slits 13 and associated fasteners 14. The fastener 14 may be a Velcro type system on opposing sides of the slit 13, an interlocking mechanism, or any other suitable fastener that may be realized by persons of ordinary skill in the art. The fastener(s) 14 allows the property owner or maintenance personnel to selectively loosen the cover 10 in order to easily remove the utility pedestal cover 10 from the utility pedestal 11 for access to the pedestal 11.

The material of the utility pedestal cover 10 may be a flexible polymeric type of material that has some stretchability in order to conform to the shape of the utility pedestal 11. The material of the utility pedestal cover 10 may also be weather resistant because the utility pedestal 11 is usually located outdoors and the material may desirably be able to withstand changing weather conditions. Weatherproof material may include such materials as vinyl, rubber, polyvinyl chloride (PVC), polyurethane (PU), silicone elastomer, and any other suitable materials that may be recognized by persons of ordinary skill in the art.

The design of the exterior of the utility pedestal cover 10 may also have different shapes, colors, logos, designs or the like. The shape of the utility pedestal cover 10 is not limited to the exact shape of the utility pedestal 11. For example, during a particular holiday season, such as the Christmas season, the utility pedestal cover 10 may have the shape of Santa Claus or a reindeer for example. The color of the utility pedestal cover 10 may also be different colors such as an earth tone color or other color that either matches the landscape or the property owner's personal preference. Designs or logos can be provided on the exterior of the cover 10, such as in relation to sports teams or other affiliations or interests of the user.

With reference to FIG. 2, the front portion of the utility pedestal cover 10 is shown. Once again, the utility pedestal cover 10 may envelope the utility pedestal 11 in order to conceal its presence on the landscape and/or to enhance the appearance of the pedestal 11.

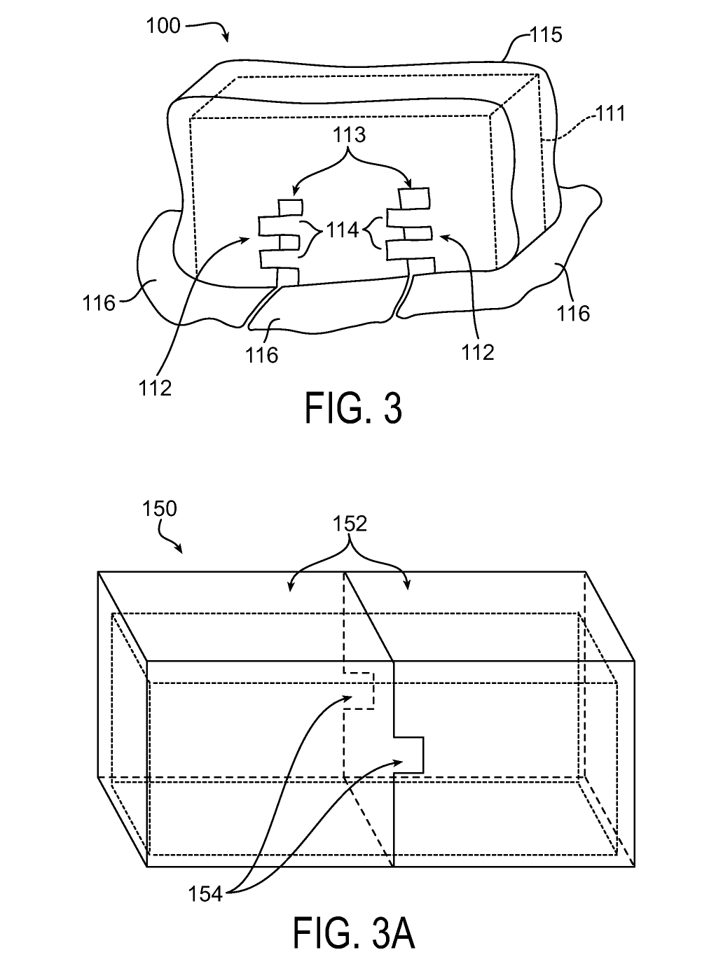

With reference to FIG. 3, another example of a utility pedestal cover 100 is shown that may envelope a utility pedestal 111. The utility pedestal cover 100 comprises an outer cover 115, a fastening system 112, and a bottom skirt 116. Once again, the fastening system 112 may comprise a slit 113 and a one or more fasteners 114, or another suitable closure system, such as a Velcro closure system on opposing sides of slit 113. The shape of the cover 100 may be generally formed to match the shape of the utility pedestal 111, and a plurality of fastening systems 112 may be provided. Again, the material of the utility pedestal cover 100 may be a flexible polymeric material that has some stretchability in order to conform to the shape of the utility pedestal 111. The material of the utility pedestal cover 100 may also be weather resistant as described with reference to the prior embodiment. Further, the design of the exterior of the utility pedestal cover 100 may also have different shapes and colors, similar to that described with reference to the prior embodiment.

With continued reference to FIG. 3, the bottom skirt 116 extends away from the utility pedestal 111 adjacent the bottom at the interface with the ground surface. The skirt 116 may have a dimension to prevent grass, weeds, or plants from growing immediately adjacent to the utility pedestal 111, thereby facilitating maintenance around the utility pedestal 111, such as mowing of grass or trimming of vegetation growing near to the pedestal 111. The skirt 116 prevents the growth or grass or other vegetation adjacent the pedestal 111, such that there is no vegetation surrounding the utility pedestal 111, and therefore no need for landscape maintenance around the utility pedestal 111.

With reference to FIG. 3A, another example of the cover according to the invention is shown, which comprises a rigid cover 150 formed of one of more sections. The rigid cover 150 may be formed of one or more molded components, and in this embodiment, is shown to have three sections 152 that are arranged together to form the cover 150. The sections 152 may be attached to one another to form a unitary type structure, with attachment provided by any suitable fastener mechanism(s) 154. In this example, the sections 152 may be attached by clamps, but other mechanisms such as interlocking tabs, straps, hook and loop fasteners, screws, clips, dowels, buckles, buttons, clasps, grommets, nails, pegs, pins, snaps, staples, ties or other suitable fasteners may be used. The rigid cover 150 may be formed of molded plastic type materials, or may be formed from other suitable materials, such as wood, metal or the like. Though the utility pedestal itself is provided with a case, the appearance of the case is not aesthetically pleasing and the cover 150 therefore provides a more pleasing appearance, as the cover can be formed to have a variety of desired appearances, such as having a desired color, graphic or other design features, and the like, to provide the desired appearance. Access to the utility pedestal is then easily obtained by lifting or removal of the cover or section thereof.

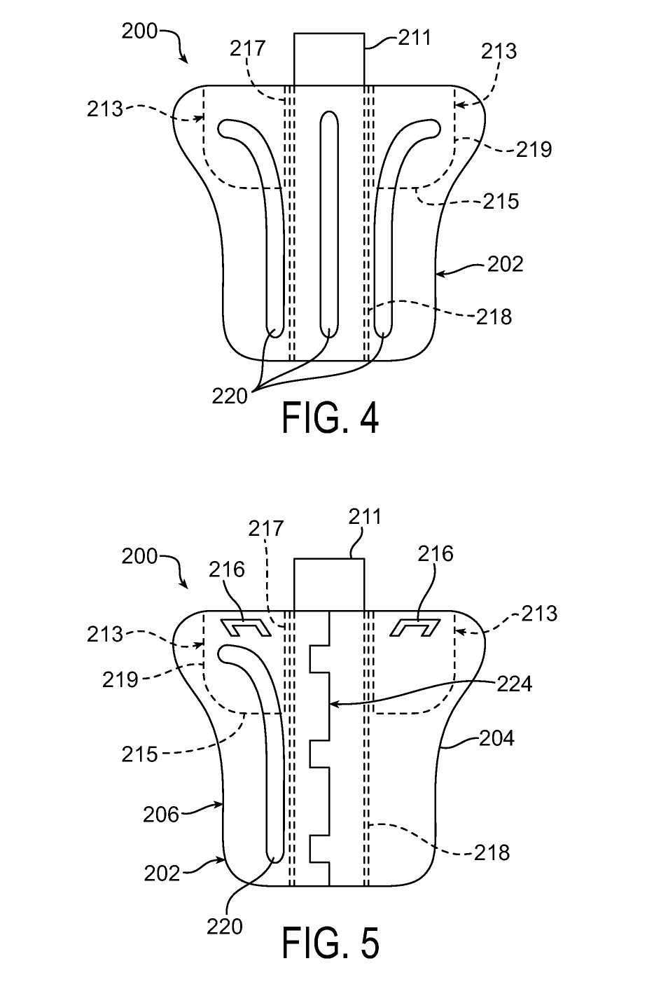

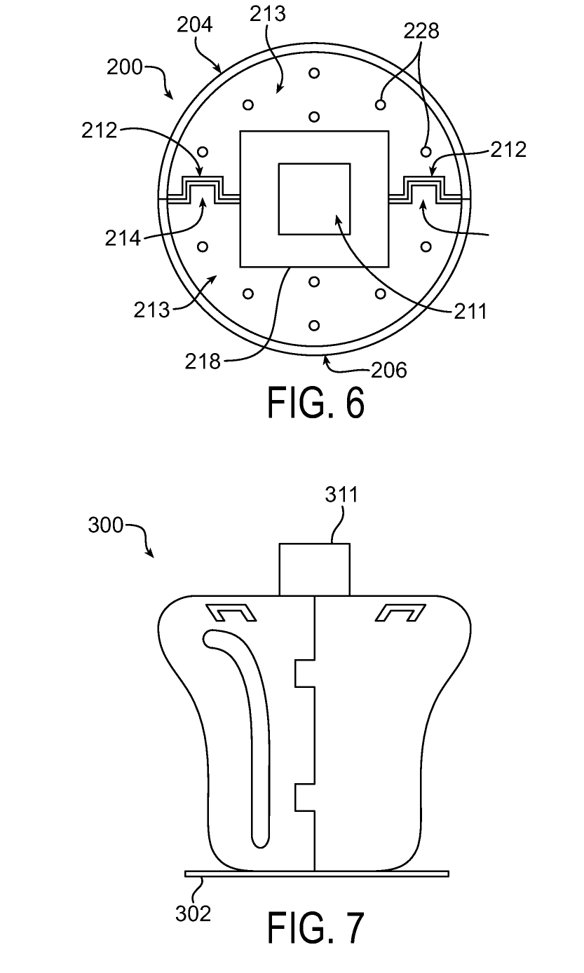

With reference to FIGS. 4, 5, and 6, an alternate embodiment of the present invention shows a utility pedestal planter 200 that may be used to surround a utility pedestal 211. The utility pedestal planter 200 may comprise a housing 202, which may be formed as a single integral unit or comprise a plurality of sections that together would surround the utility pedestal 211. In the embodiment shown, the housing 202 comprises first and second sections 204 and 206 that may be formed to engage with one another to simulate a single member. Alternatively, the sections 204 and 206 (or additional sections) may be positioned together to simulate an integral unit without actually interlocking. The housing 202 may be configured to have any desired appearance, such as simulating a ceramic planter pot, or any other configuration, and can be constructed of any suitable material, such as plastic, wood, ceramic, metal or the like. The exterior of the planter 200 may have designs or other ornamentation thereon as may be desired, such as shown at 220, to provide planter 200 with a more pleasing appearance. One or more handles 216 may be provided on the exterior to facilitate handling. For example, another planter handle 216 may be positioned on the interior or near the bottom of the utility pedestal planter 200. To facilitate positioning of the planter around the utility pedestal 211, ground engaging portions (not shown), such as spikes or the like may be used. The housing 202 has an interior wall 218 that is configured to extend around the utility pedestal 211. In this example, the pedestal 211 is of columnar shape, and the interior wall 218 is formed in a u-shape in each section 204 and 206 to form a square or rectangular open space together which accommodates the pedestal 211.

In the example shown in the Figs., the housing members or sections 204 and 206 may be engaged and secured to one another by any suitable system, such as a series of interlocking members 212 and 214 formed on respective housing members 204 and 206. In this example, the interlocking members 212 and 214 are male and female sections which engage one another, but any suitable system is contemplated. For example, engagement between the sections 204 and 206 may be provided by buckles, latches, fasteners, hinges, or any other suitable system as recognized by persons of ordinary skill in the art. The housing 202 also may have a planting section or well 213, which in this example is formed in each housing member 204 and 206. The planting well 213 provides the cavity in which soil or other planting media is positioned for the planting of flowers, plants or other vegetation. If desired, artificial plants, flowers or the like may be used to provide the desired appearance. Each planting well 213 may have a bottom wall 215, an outer side wall 216 and an inner side wall 217 to define a cavity in which a planting medium can be positioned. The bottom wall 215 may have one or more drainage holes 218 therein to allow water from rain or user watering to drain from cavity or well 213. The inner wall 217 forms a central opening to accommodate the utility pedestal 211 interior to the planter 200.

With continued reference to FIGS. 4, 5, and 6, the utility pedestal planter 200 of this example may disconnect into two separate pieces or sections 204 and 206, in order to allow the property owner or maintenance personnel access to the utility pedestal 211. The sections 204 and 206 may engage one another as described, such as by interlocking members as described. In this way, the sections 204 and 206 can be disengaged to allow access to the pedestal 211 when needed, without having to lift the planter 200 over the pedestal 211. If desired, the sections 204 and 206 could be hingedly engaged on one side to allow relative rotation of one section to the other for access to the pedestal 211, or as indicated, may not be engaged at all, such that the sections can simply be moved if needed.

Furthermore, according to the present embodiment, the utility pedestal planter 200 includes two different halves, but the utility pedestal planter 200 may be constructed to disconnect into multiple pieces as may be desired. For larger pedestals 211, it may be desirable to have additional sections to encompass the pedestal 211, while simplifying access to the pedestal when needed. The present invention therefore contemplates many configurations which can encompass a particular utility pedestal 211, with the configuration of the planter 200 being of any suitable or desired shape, size, number of sections, materials, color, etc. Further, though the sections 204 and 206 are shown to be minor halves, such sections can be of different configurations, shapes, dimensions, heights or the like to give a desired appearance together.

In this example, the provision of planting wells or cavities 213 in the sections 204 and 206 allow planting of flowers or plants, while minimizing the amount of dirt or planting medium needed, and minimizing the weight of the planter 200 and sections 204 and 206 when filled. The plant housing well 213 may also be divided into separate wells if desired, with different configurations or depths as may be desired. For example, multiple plant housing wells surrounding the inner opening may be provided, at the same or different levels.

Continuing to reference FIGS. 4, 5, and 6, the size of the utility pedestal planter 200 may also vary depending on the size of the utility pedestal 211. The larger the utility pedestal 211, the larger the utility pedestal planter 200 may be. The height of the utility pedestal planter 200 may also be tailored for use with a particular pedestal 211, and may have a height to extend a desired amount relative to the pedestal 211. For example, the planter 200 could have a height to extend between one-half to three-fourths (¾) the height of the utility pedestal 211. Plantings therein would then extend up to conceal the pedestal 211 for example. The utility pedestal planter 200 may also be constructed of a plastic material such as polyethylene, polyvinyl chloride, to keep the weight down, or any other suitable materials as described.

With reference to FIG. 7, another alternate embodiment of the present invention may show a utility pedestal planter 300 that may encase a utility pedestal 311. The utility pedestal planter 300 may comprise a similar structure or configuration as described previously and as contemplated, and may further have a bottom skirt portion 302. The bottom skirt portion 302 extends away from the utility pedestal 311 adjacent the bottom at the interface with the ground surface. The skirt 302 may have a dimension to prevent grass, weeds, or plants from growing immediately adjacent to the utility pedestal 311, thereby facilitating maintenance around the utility pedestal 311 or planter 300, such as mowing of grass or trimming of vegetation growing near to the pedestal planter 300. The skirt 302 prevents the growth or grass or other vegetation adjacent the planter 300, such that there is no vegetation surrounding the planter 300 for some distance, and therefore no need for landscape maintenance directly around the planter 300. this may simplify mowing of grass around the planter 300 for example.

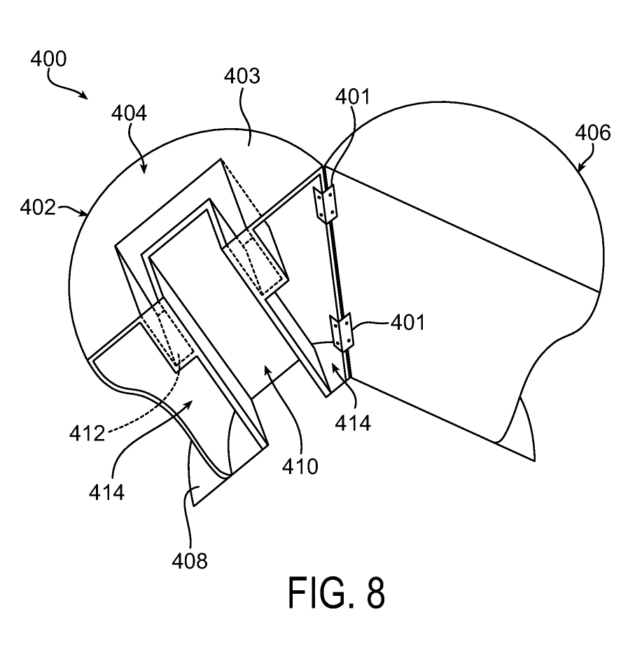

With reference to FIG. 8, an embodiment of the present invention is shown at 400 in an “opened” position, with the planter housing 402 having two halves 404 and 406 which are hingedly connected to one another. More specifically, the utility pedestal planter 400 may comprise hinges 401, a plurality of plant housing wells 403 in each section 404 and 406 (with only one shown in the section 404). The housing sections 404 and 406 may have an associated bottom skirt 408, an inner opening 410, a false bottom 412 in wells 403, and an internal open region 414. Both halves of the utility pedestal planter 400 may be connected together by the hinges 401, and the hinges 401 may allow the two halves of the utility pedestal planter 400 to open and close according to the amount of space necessary to access the utility pedestal. The hinges 401 may be metal fasteners, butt hinges, butterfly hinges, flush hinges, barrel hinges, continuous hinges, piano hinges, and any others that may be realized by persons of ordinary skill in the art. The internal region 402 may also be hollow to allow the utility pedestal planter 400 to be as light as possible when filled with dirt and plantings. This may allow the property owner or maintenance personnel easy access to the utility pedestal because the utility pedestal planter 400 may be easily opened. However, the internal region 402 may be solid or semi-solid in order to create a more durable utility pedestal planter.

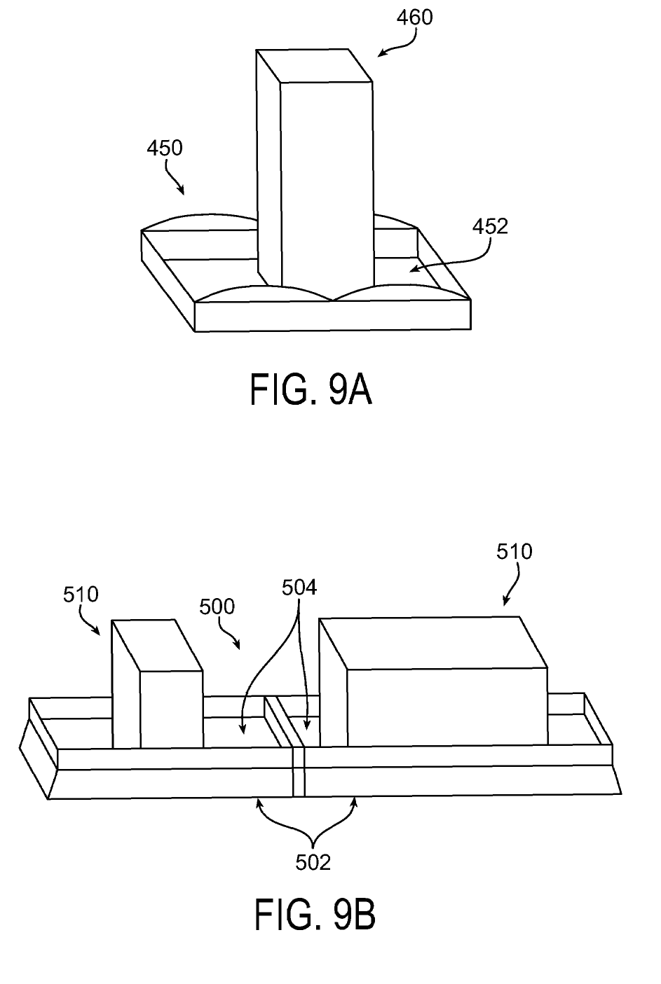

Further embodiments of a planter system according to the invention are shown in FIGS. 9A-9B as examples, and it should be recognized that a wide variety of other arrangements could be used and are contemplated according to the invention. In FIG. 9A, the planter 450 is formed as a low profile system having a planting area 452 surrounding the utility pedestal 460, to hold a planting medium therein. Plants, flowers or the like may then be planted in the planter 450 to effectively hide or conceal the utility pedestal 460. The plants, flowers or the like that may be planted therein may have a height to facilitate concealing the pedestal 460, or a separate cover such as described previously may also be used to facilitate obtaining a desired appearance. The planter 450 may be formed as an integral member or can be made in sections if desired. In FIG. 9B, a planter configuration 500 may include one or more sections 502, which are each used in association with a utility pedestal 510. In many cases, several utility pedestals 510 are positioned in the same vicinity, and the planter arrangement 500 may be configured to facilitate concealing each of the pedestals 510. As in prior examples, the planter sections 502 may have planting wells or cavities 504 in which a planting medium can be positioned. Other aspects of examples of the planter systems can also be incorporated. The planter sections 502 may be attached to one another or provided as separate members.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

What is claimed is:

1. A utility pedestal cover comprising:
an outer cover member having a shape matched to the shape of a predetermined utility pedestal, the outer cover formed to selectively encase the predetermined utility pedestal; and
at least one fastener provided in association with the cover, wherein the cover is selectively positioned over the predetermined utility pedestal to provide a more aesthetically pleasing appearance in association therewith while be selectively removable for access to the utility lines contained in the utility pedestal.

2. The cover as defined in claim 1, wherein the material of the outer cover is weatherproof material.

3. The cover as defined in claim 1, wherein the at least one fastener is a hook and loop fastener.

4. The cover as defined in claim 1, wherein the outer cover is formed of a flexible material to conform to the shape of the utility pedestal.

5. The cover as defined in claim 1, wherein the outer cover further comprises a bottom skirt that extends outwardly at the bottom of the cover from the base of the utility pedestal, to substantially prevent vegetation growth around the utility pedestal.

6. A planter system comprising:
at least one housing member;
the at least one housing member having at least one planting well in which a planting medium is positioned, and an open central area to accommodate an article, wherein the at least one housing is selectively positioned around a predetermined article, to provide a more aesthetically pleasing appearance in association with the article while being selectively removable for access to the article.

7. The planter as defined in claim 6, wherein the housing includes a plurality of sections.

8. The planter as defined in claim 7, wherein the plurality of sections are interlocked to one another.

9. The planter as defined in claim 8, wherein at least some of the plurality of sections are hingedly attached to one another.

10. The planter as defined in claim 6, wherein the article is a utility pedestal and the height of the housing member is at least one-half to three-fourths (¾) the height of the utility pedestal.

11. The planter as defined in claim 6, wherein the outer wall of the at least one housing member has ornamental features.

12. The planter as defined in claim 6, wherein the at least one housing member is made of a plastic material.

13. The planter as defined in claim 7, wherein the at least one housing member has a shelf formed in at least one well.

14. The planter as defined in claim 13, wherein the shelf has at least one drainage hole therein.

15. The planter as defined in claim 7, wherein the at least one housing member further comprises a bottom skirt, to substantially prevent vegetation growth around the planter.

16. A method for concealing a utility pedestal comprising the steps of:
providing a utility pedestal planter system having at least one housing section with at least one planting well therein, designed to be used with a predetermined utility pedestal,
selectively placing the utility pedestal planter housing in association with a predetermined utility pedestal to conceal at least a portion of the utility pedestal.

17. The method of claim 16, wherein the utility pedestal planter system comprises a plurality of housing sections positioned relative to one another and positionable in a first open position and a second closed position;
wherein the sections are selectively positioned around the utility pedestal in the first open position, and then closed around the utility pedestal into the second closed position.

18. The method of claim 17, wherein at least some of the plurality of sections are hingedly attached to one another.

19. The method of claim 16, wherein the utility pedestal planter system comprises at least one planting well in which a planting medium is selectively positioned, and an open central area to accommodate the utility pedestal, wherein the at least one housing is selectively positioned around a predetermined utility pedestal.

20. The method of claim 16, wherein the at least one housing member has a shelf formed in at least one well, wherein the shelf has at least one drainage hole therein.
